(19) United States
(12) Patent Application Publication
(10) Pub. No.: US 2007/0005548 A1
(43) Pub. Date: Jan. 4, 2007

(54) System for enabling users to create tasks

(76) Inventor: Sean Kelly, Victoria (AU)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/569,338

(22) PCT Filed: Aug. 20, 2004
(86) PCT No.: PCT/AU04/01113

§ 371 Date: Feb. 21, 2006

(51) Int. Cl. G06F 17/30

(52) U.S. Cl. 707/1

(57) ABSTRACT

There is disclosed a system for enabling a user to create at least one task. The system comprises a host server (300) for hosting task pages once they have been created, at least one user computer (302) running a browser program operable by at least one user to access task pages hosted by said host server that said at least one user has permission to access, and a task creator configured to create a task record in response to a command from an initiating user, the task record including a task universal resource indicator (uri) for each new task whereby said host server can create a task page from said task record that can be accessed using said task uri.

The present application claims priority of Australian provisional patent application no. 2003904507, the disclosure of which is incorporated herein by reference.

### FIELD OF THE INVENTION

The present invention relates to a system for enabling a user to create at least one task that is particularly suited to enabling users to communicate with one another in relation to tasks.

### BACKGROUND TO THE INVENTION

There are a number of existing systems which allow users to communicate with one another over the Internet. These systems, such as MSN Messager, a product of Microsoft Corporation, require users to download an application, install the application and run the program in order to be available to other users.

A deficiency of these systems also require each person wanting to use the system to obtain a copy of the software. Typically, this requires the user to register for the service at a particular website from their browser. Accordingly, there is a need for an alternative system.

### SUMMARY OF THE INVENTION

Accordingly, the invention provides a system for enabling a user to create at least one task, the system comprising:
a host server for hosting task pages once they have been created;
at least one user computer running a browser program operable by at least one user to access task pages hosted by said host server that said at least one user has permission to access; and
a task creator configured to create a task record in response to a command from an initiating user, the task record including a task universal resource indicator (uri) for each new task whereby said host server can create a task page from said task record that can be accessed using said task uri.

Thus, in its broadest aspect the invention provides a convenient mechanism for a user to create a task which can be accessed by a browser.

Preferably, said system comprises a plurality of user computers each running a browser program and said task creator is configured to allow the initiating user to specify at least one additional user for a task and to create an association record specifying the initiating user and any additional users specified by the initiating user, the association record defining the users who have permission to access the task page.

Preferably, when the initiating user specifies at least one additional user, the task creator dispatches a message including the task uri to the at least one additional user to thereby inform the at least one additional user of the task whereafter the at least one additional user can access said task page using the browser program run by the additional user's user computer.

The message will typically be an e-mail message and/or an SMS message.

Typically, the task creator is a task creation program run by said host server which is operable using the browser program run by the initiating user's user computer.

Preferably, said task creator allows an initiating user to add at least one subject uri of at least one subject page to the task record, whereafter the task page includes the at least one subject uri whereby users can access the subject page from the task page.

In a particularly preferred embodiment of the invention, a task creation uri is placed on a subject page and the initiating user sends a command to said task creator by selecting the task creation uri whereafter the task creator creates a task record including the uri of the subject uri.

Task creation from a subject page may automatically include an additional user in the task record. For example, a user associated with the subject page, such as a salesperson for a product referred to on the subject page.

In another embodiment, a task creation uri is stored in a uri record of the browser and when viewing a subject page an initiating user sends a command to said task creator by selecting the task creation uri from the uri record whereafter the task creator creates a task record including the subject uri.

In some embodiments, a task addition uri may be provided either on a subject page or in a uri record of the browser and selecting the task addition uri commands the task creator to add the subject page to an existing task record.

It is preferred that the host server hosts a home page for each user and it is further preferred that the home page is configured such that users can access all tasks which they have permission to access from their respective home pages.

Thus, a user can access task pages from the user's home page as an alternative to accessing a task by means of the task uri.

The system preferably further includes an event creator for creating events associated with a task.

Preferably the event may be created from the task page.

Preferably, the system has a chat means which allows users who have permission to access a task to chat to one another.

Preferably, each task page has means for initiating a chat.

### BRIEF DESCRIPTION OF THE DRAWINGS

Further features of embodiments of the invention will become apparent from the following description of the drawings in which:

FIG. 1 shows a typical log-in page;

FIG. 2a shows a first page showing a portion of a home page;

FIG. 2b shows a second page showing a portion of a home page;

FIG. 3 shows a log-in and home page flow chart;

FIG. 4 shows a page for creating a new task;

FIG. 5 shows a first task detail page.

FIG. 6 shows a secondary task detail page;

FIG. 7 shows a contact page for a task;

FIG. 8 shows an SMS message box;

FIG. 9 shows a contact detail page;

FIG. 10 shows a fourth task detail page;

FIG. 11 is a task detail page flowchart;

FIG. 12 is a data page flow chart;

FIG. 13 shows an event/contact detail page;

FIG. 14 shows an event reply page;

FIG. 15 shows a contact addition page;

FIG. 16 shows a contact list page;

FIG. 17 shows a contact search page;

FIG. 18 shows a chat detail page;

FIG. 19 is a chat page flow chart;

FIG. 20 shows a preferences page;

FIG. 21 shows a typical system configuration; and

FIG. 22 shows an update frame.

### DESCRIPTION OF A PREFERRED EMBODIMENT

An embodiment of the invention provides a system for enabling users of a plurality of computers to create tasks and to communicate with one another in relation to the tasks. Herein, the word “task” is used to describe any communication by users in relation to a subject. For example, the task could relate to a meeting, a project, an opportunity, a tender, an article, a party, a web page a sporting activity or any other activity in relation to which a group of people may desire to communicate. Herein, tasks are also referred to as “quick-links” or by the abbreviation “QL”. Quick Link is a trade mark of Lost Boys Pty Ltd.

There may be a number of sub-communications within each task. Herein, these sub-communications are referred to as “events”. The events of a task may relate to different aspects of that task. For example, if a task relates to a project, one event may relate to a meeting of the project team, another event may relate to a paper the team is working on, and another event may report on a communication received from an outside contractor.

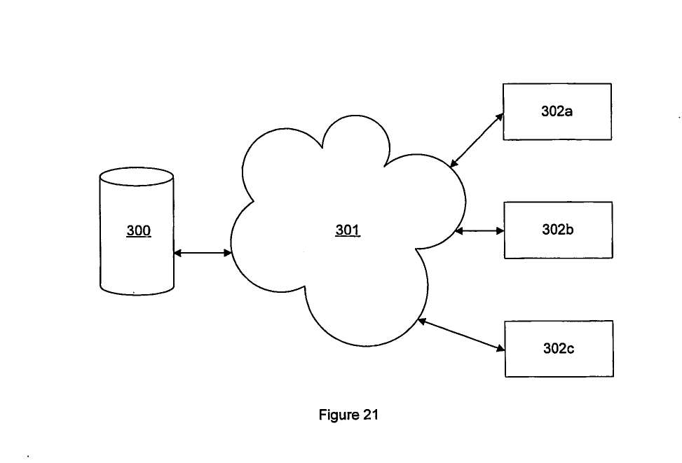

As shown in FIG. 21, the system has a host server which hosts data relating to web pages of the system. It will be appreciated by persons skilled in the art that the host server may consist of one or more computers which are connected to one another. The system also has a plurality of user computers 302 each of which run browser programs operable by users to access web pages hosted by the host server via the Internet 301. Again persons skilled in the art will appreciate that while a computer 302 will typically be a personal computer, it may be any other computing device which is capable of running a browser program such as a personal digital assistant. As all aspects of the system can be used through a browser program, a user does not need to have specialised software installed on their user computer 302. Indeed, the system can replace e-mail, file sharing, and contact management software. Further, as the system acts as a type of virtual private network, users who only use the system should not require spam filtering.

As with the host computer 301, a user computer 302 may be one or more computers. Or a user may use alternative computers provided those computers run browser programs.

While particularly advantageous aspects of the preferred embodiments of the invention are the manner in which new tasks are created and new users are added to the system, the preferred embodiment will initially be described from the perspective of an existing member of the system.

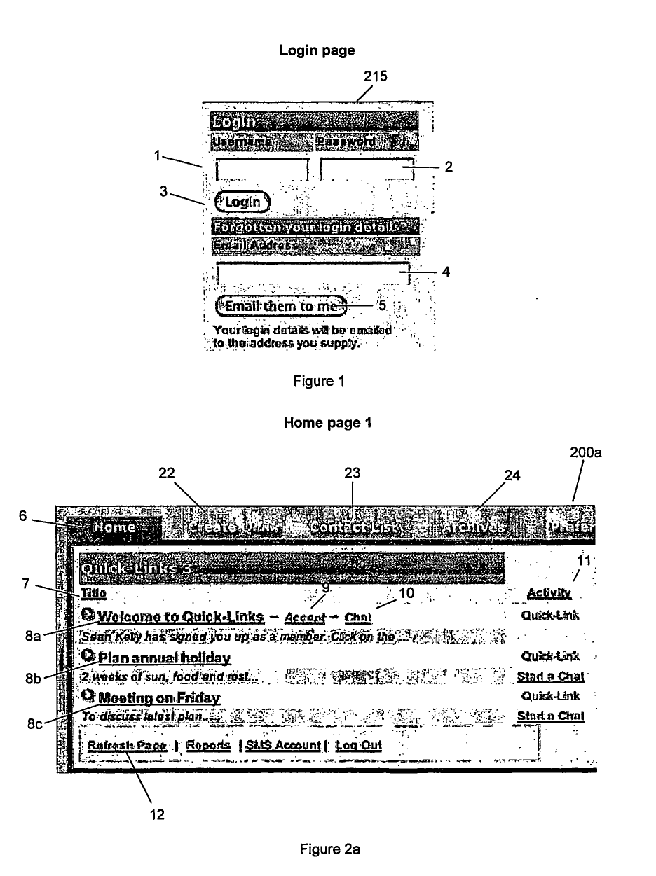

FIG. 1 shows a typical log-in page 215 which a user can access by inputting a universal resource indicator (uri) for the system into a browser program such as Microsoft Internet Explorer or Netscape Navigator. A user enters their user name into user name field 1, their password into password field 2 and submits their log-in details by clicking on log-in button 3.

If a user has forgotten their log-in details they can insert their e-mail address into e-mail address field 4 and click on button 5 to have their log-in details e-mailed to them.

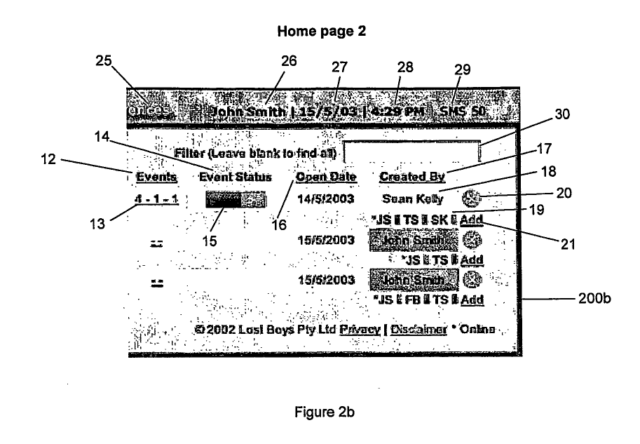

Once the user is logged in, the user is taken to a home page 200. Part 200a of the home page is shown in FIG. 2a and the remainder 200b of the home page is shown in FIG. 2b.

Each user's home page 200 has a number of tabs 6, 22, 23, 24, 25. Tab 6 is the home page tab and lists the tasks 8 which are current for the user John Smith in the title column 7. Referring to FIG. 1, the user has three tasks 8a, 8b and 8c. Clicking on the word “Title” at the top of the title column allows a user to sort tasks alphabetically or by date of creation. Next to task 8a, the user is presented with two options “accept” 9 and “chat” 10. Clicking “accept” will send an e-mail to the user who created the task informing them that John Smith has accepted the task 8a. Accepting task 8a also makes John Smith's contact details public to other users who have permission to access the task. Herein the “initiating user”—i.e. the user who initiates creation of a task is known as the owner of the task and all the other users are known as additional users. By clicking on the word chat 10, a chat page is opened in respect of the task. The chat function will be described in further detail below. Tasks 8b and 8c are established tasks where the user has already accepted the task and accordingly there is no accept button and the chat button 10 has been relocated into the activity column 11. The activity column specifies the task type—e.g. tasks can be designated as being a quick-link, a project labelled with other nomenclature that describes the type of task. Clicking on the word “activity” at the top of column activity column 11 allows the tasks to be sorted in accordance with type.

When a user has been logged on for a period of time they may wish to check that there have been no new tasks or changes to tasks. Accordingly, they may click on “refresh page” to get updated information from the server.

The events column 11 shown in FIG. 26 shows the number of events associated with each task. Clicking on the number of events 13 takes the user to the event page 205. The nomenclature 4-1-1 indicates that there are four new events, one pending event and one complete event. This is mirrored in the event status column which is a colour bar that is coloured red, amber and green for new, pending and complete tasks respectively. The proportions of the bar which are coloured in the colours red, amber and green reflect the relative numbers of new, pending and complete tasks.

The next column is the “open date” column 16 which indicates when the task was initiated. The final column 17 is the “created by” column. It shows that task 8a was created by Sean Kelly (the initiating user for this task). It also shows under the name of the initiating user, the list of users who have permission to access this task by listing their initials. There is also a delete button 20 for deleting the task and an add button 21 for adding additional users to the task.

A number of additional pages are accessible from the home page. Clicking on tab 22 takes the user to the page for creating a new task 201, clicking on tab 23 opens the contact list page for the user, clicking on tab 24 takes the user to archived task pages, clicking on the preferences tab 25 takes the user to the preferences page 211. There is also user information along the top right of the page including the name of the user 26, the date the page was last downloaded 27, the time at which the page was last downloaded 28 and the number of SMS messages 29 which the user has left. There is also a filter box 30 which allows the user to filter tasks by entering a keyword such as “meet” to locate meeting tasks.

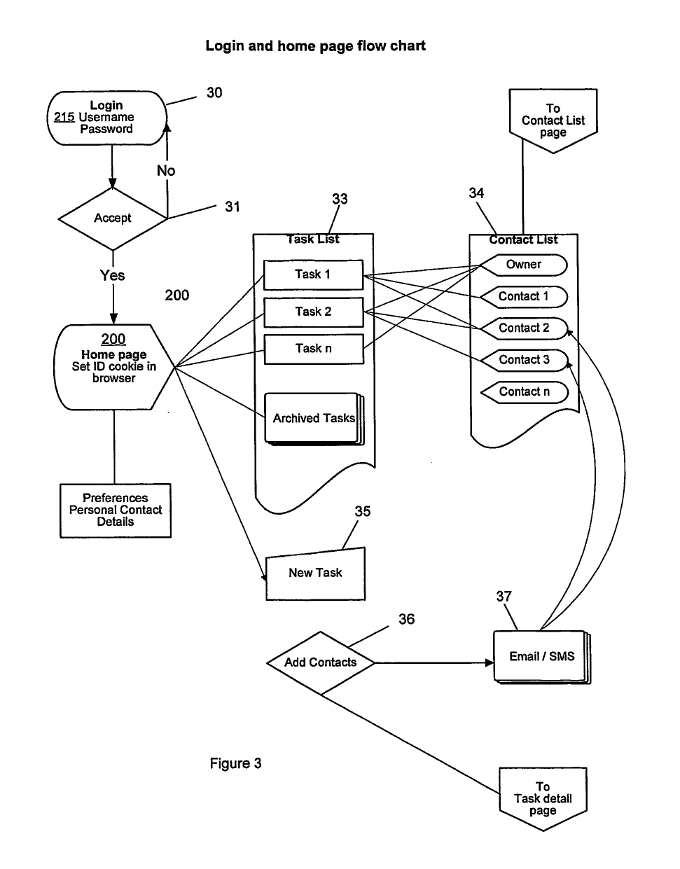

Referring now to FIG. 3, the log-on process is shown in the form of a flow chart. At step 30 a user attempts to log-on, at step 31, the system decides whether to accept the log-on. If the system approves the log-on attempt, at step 32, the system gives the user access to the user's home page and sets an ID cookie for the user in the user's browser. The diagram shows that the user has a task list 33 of all their tasks including archived tasks and a contact list 34. Each task in the task list 33 is associated with particular contacts in the contact list. There may be users who are associated with a task who are not on the contact list page. For example, if they have been added by another party to the task. If a user chooses to add a new task, the user selects the new task page, at step 35, adds contacts at step 36, messages such as an e-mail or SMS message are sent at step 37 to each of the added contacts which in this case are contacts 2 and 3 and then the user goes to the task detail page 201 to enter details of the past task as will be described in more detail below.

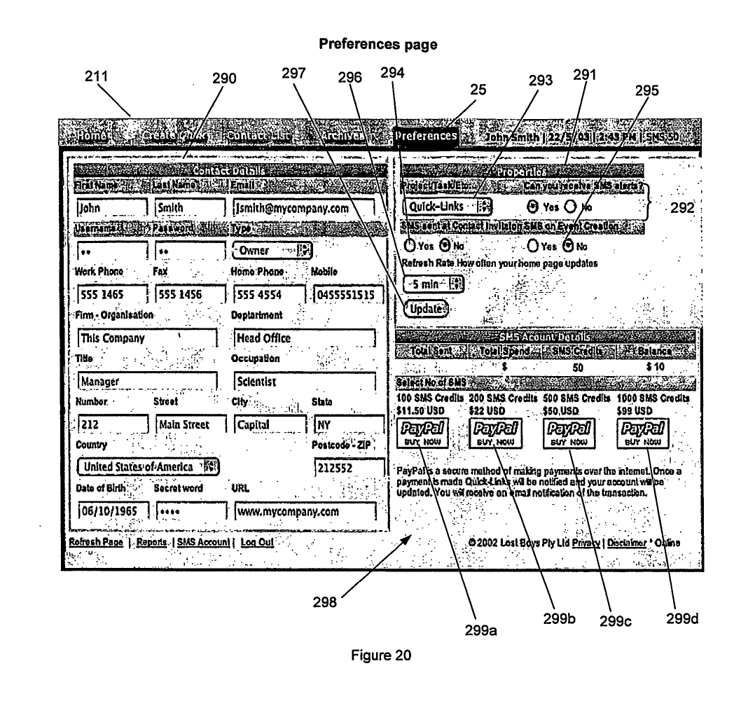

Persons skilled in the art will appreciate that it is not efficient to maintain separate pages for each user and each task, accordingly, there a number of data bases which are stored by the host server in such a manner that they allow the pages to be constructed and served to users on demand by the server. The first of these databases is an entity database which contains information about each user, e.g. a name, password, and ID number. Many additional details are kept as shown, for example in FIG. 20. That is, most of the details on the preferences page shown in FIG. 20 are also kept. Persons skilled in the art will appreciate that a wide range of details can be kept.

In addition to the entity data base there is an entity association data base. The entity association data base maintains a list of other entity ID numbers for other users which are associated with the entity.

When a member logs on, a search is performed of the entity data base and if the user name and password match a record in the entity data base a cookie containing the user's entity ID number is set in the user's browsers. This cookie lets the system know which entity is requesting information from the system as they move from page to page, thus, when a user accesses their contact list page a search is performed of the entity association data base to find all matches of the ID number in the cookie to an entity ID number owner. These records contain links to the contact information of the other entities (users).

There is also a task entity data base which contains records for each task. The creator of the task or initiating user has “ownership” status; only they can edit the title and description of the task, add Notes, or specify the activity type. For each task, a record is created in the task data base. Associated with the task data base is the task/entity association data base. The task entity association data base specifies the initiating users and additional users who have an association with the task—i.e. permission to access the task. Accordingly, a user's cookie can be used to search the task/entity association data base to determine tasks which are associated with the user in order to display these tasks in their home page.

There are also event and event/entity data bases for managing events associated with tasks. As with the task data base, there is a record in the event data base for each event and there are records in the event entity association data base related to the specific users who are associated with the event. Accordingly, the server can search the event/entity data base in order to provide a list of all events for a particular user.

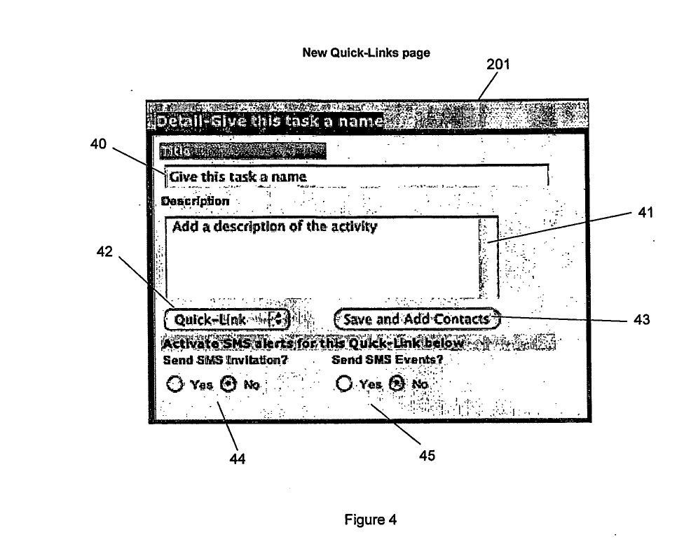

Referring now to FIG. 4, there is shown a new task page. The user access this page by selecting the “create q-link” tab 22 (i.e. the task tab) from their home page 200. The user who as they are creating the task is referred to as the initiating user is then prompted to specify the detail for the task. By providing and submitting the detail, the initiating user is providing a command to a task creation program (“task creator”) run by the server to create a new task record. Each new task record includes a universal resource indicator specific to that task (“task uri”).

The user can enter a title in title box 40 in description box 41. In the preferred embodiment, the user has the opportunity to select from a number of different task types. These task types using a scrollable menu contained in task box 42. In the preferred embodiment the task type does not affect the nature of the task. However, persons skilled in the art will appreciate that different types of tasks may have different fields associated with them and accordingly require the user to specify different information. The types of tasks may include projects, meetings, etc. The person clicks on the contact button 43 to save and add contacts to the task. This takes the user to the contact add page which will be described in further detail below.

Default messaging in the system is by way of e-mail messaging. However, the user has the option to add additional forms of messaging. In the preferred embodiment, the user has the option to add short message service messaging. SMS invitation buttons 44 allow the user to select whether an SMS invitation should be sent to users which are invited to join this new task. SMS event buttons 45 specify whether SMS messages should be sent each time a new event is added to the task.

The use of SMS messaging to transmit a message to a user's mobile terminal is a convenient way of keeping users abreast of tasks. In particular, it allows users who are away from their computers to be kept in contact with a task or to be advised that they need to check on the progress of a particular task.

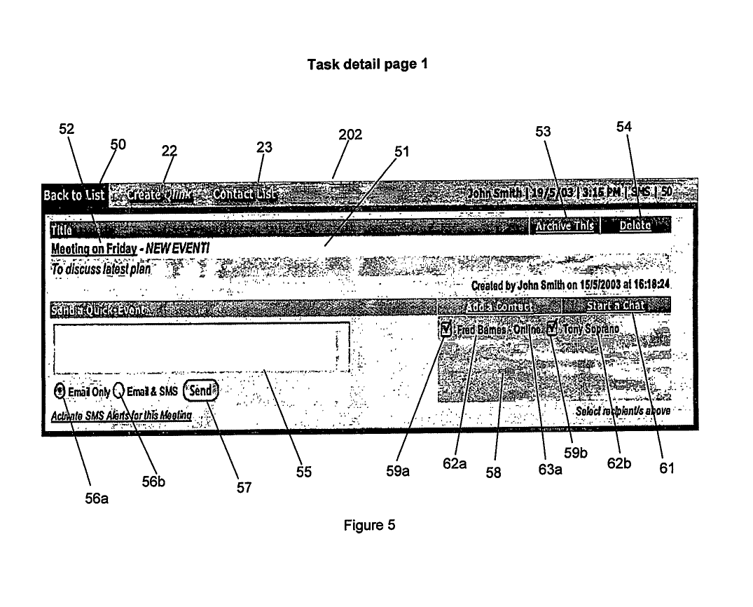

Referring to FIG. 5, there is shown a task detail page 202. This task detail page has been accessed by the user selecting task 8c from home page 200. The task list has a “back to list” tab 50 which allows the user to return to home page 200, and has the create quick-link and contact list tabs 22, 23 that are also found in the home page. The title of task 8c is shown.

Title and subject area 51 shows the name of the task and description of the purpose of the task. The words “new event” show when a new event has been added since the user last visited their home page. Provided the user is the owner of the task (i.e. the user who initiated the task) a user can click on the title 52 in order to edit the title, the description and any notes associated with the task.

Archive link 53 allows the user to archive a task once it has been completed. Delete button 54 allows the owner of a task to delete the task once it has been completed or is no longer relevant. The delete button is only visible to the owner of the task. The send event box 55 allows the user to enter details of a new event. Below this area are message type selection buttons 56a and 56b which allow a user to select whether to send the message by e-mail only 56a or by e-mail and SMS 56b. Once the user has entered details of their event. For example “I have arranged a meeting at 3 pm on Thursday with our financial backer can you attend?” the user can send the task message to the contacts (i.e. users) specified in contact box 58. By default, the event will be sent to all of the users associated with the task. For each user, in this case Fred Barnes and Tony Soprano, there are checkboxes 59a and 59b respectively. When the respective check boxes are checked, the event will be sent to this user when the send button 57 is clicked. Thus, the user can deselect particular checkboxes 59 in order to exclude a particular user from an event. For example, it may be the case that only Tony Soprano's presence is required at the meeting with the financial backer referred to above. The system of the preferred embodiment also has the capability to add additional contacts from the task page selecting add contact button 60 takes the user to the contact list page 208. This may be used to add a contact for a specific event. For example, to add the details of the financial backer in order to confirm details of the meeting. There is also a chat start button 61 which opens a chat page with all users who are online. (If the user is online, an online status 63 is displayed next to their name 62.)

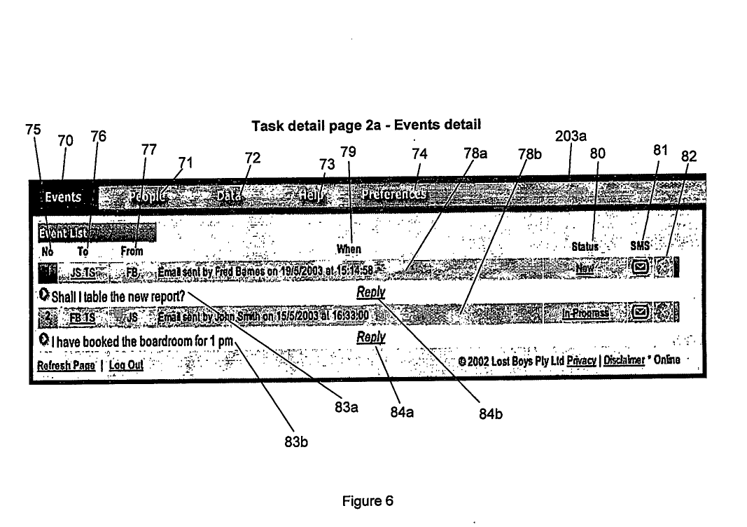

Referring to FIG. 6, there is shown the secondary task detail page 203. The secondary task detail page is normally displayed immediately below the task detail page 2 in order to display all of the information associated with a particular task. The events list displays when the events tab 70 is selected by the user. Selecting the people tab 71 transfers the view to a display of all the contacts associated with the task. Selecting the data tab 72 shows all web pages that are linked to this task. Selecting button 73 brings up a help screen and selecting button tab 74 transfers the user to the preferences page 211.

The event list has a number of columns which specify different aspects of the task. Number column 75 shows the number of the task, 76 shows who the task was sent to and column 77 shows who the task is from. In each of these columns, the initials of the users associated with the task are displayed. It will be apparent to persons skilled in the art that the size of the boxes displaying the initials can be increased as necessary or made scrollable to accommodate a larger number of users. The events which are visible to a user are only those where the user's initials are either in the to or from column. In this case the user is John Smith and J S is in the to column of the first event 78a and the from column of the second event 78b. The “when” column 79 specifies when the event was created. The “status” column 80 specifies whether the task is new, in progress, or completed. The SMS, e-mail or both column specifies whether the event was sent by SMS and at the right hand end of the page there are delete buttons 82 which allows an event to be deleted. Under the detail for each message is the subject 83 of the event 78. For example, for event 78a, there is the message “Shall I table the new report?”. Similarly, for event 78b there is the message “I have booked the boardroom for 1 pm” 83b. Associated with each of the tasks 78 are reply buttons to allow users to reply to an existing event. Selecting the reply button 84a, 84b transfers the user to the reply page 206. The user's reply is then added to the event. Referring to status column 80, the user can select the status from the status column in order to change the status.

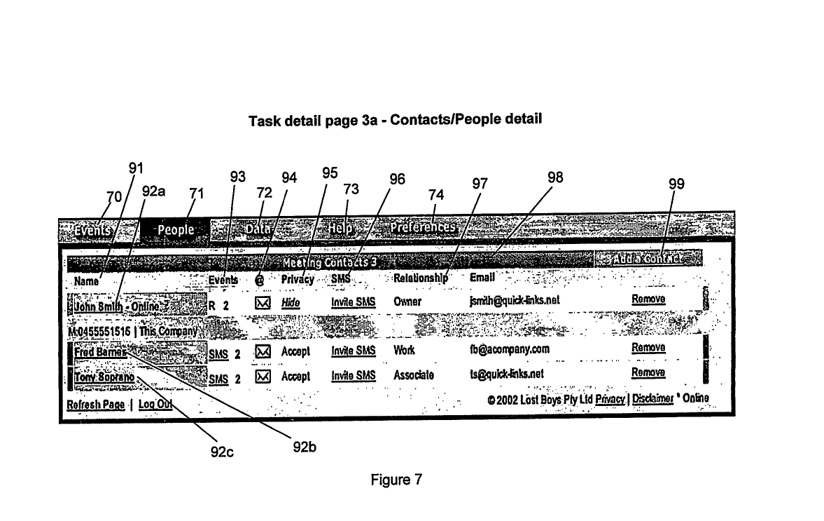

Referring now to FIG. 7 there is shown the people page 203b selected by the people tab 71 of the event detail page 203a. The name column 91 lists the names of each of the users associated with the task, whether they are online and whether they have accepted a task. Acceptance is indicated by acceptance bars 92 which are either coloured green as is the case with acceptance bar 92a or red as is the case with acceptance bars 92b and 92c to indicate whether a user has accepted a task. Clicking on the names will take the user to the contact detail page 204 for that user.

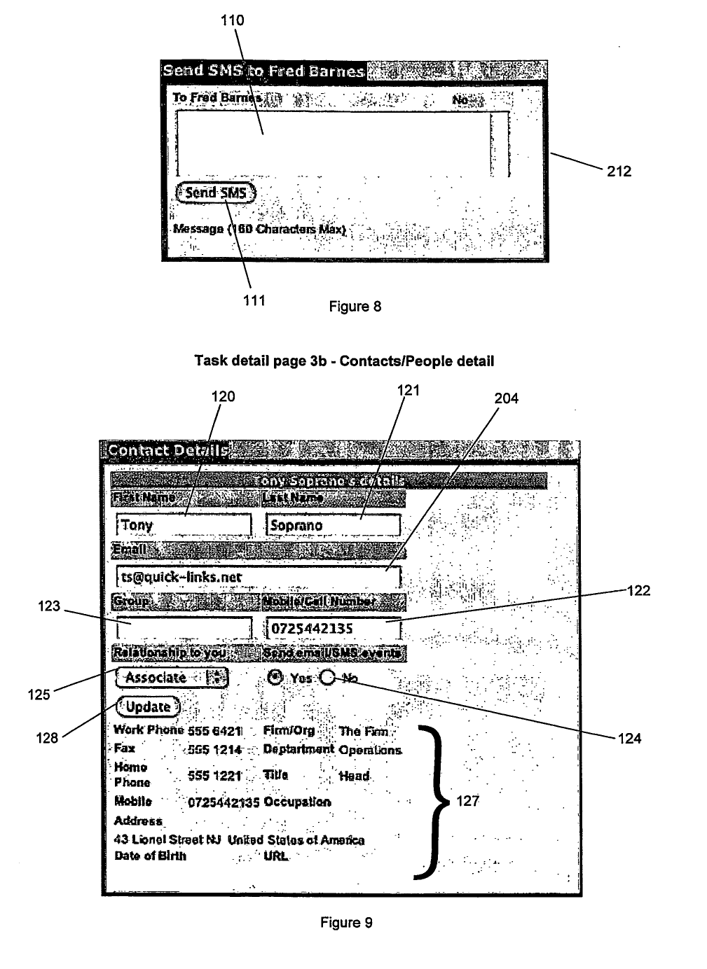

The event column specifies whether the user can receive SMS by the designation “R” as well the number of events to which they are linked by means of a numeral. Clicking on “SMS” opens the send SMS box 212 which is shown in FIG. 8. This allows a user to compose and enter an SMS message into area 110 and to send the SMS message by pressing button 111. The “@” column 94 shows an e-mail program icon and indicates whether an e-mail message can be sent to the user. Privacy column 95 indicates the privacy status. John Smith is the owner or initiating user of this task. Currently John Smith's details are available for others to view. Accordingly, in the privacy column 95 there is shown a “hide” link which allows the initiating user to change the status of the privacy of their contact details to hidden. The word “accept” in this column indicates that Fred Barnes and Tony Soprano allow their details to be viewed.

The SMS invite column 96 allows the user to send an invitation SMS message to a user in order to enable them to join a task by clicking on the invite SMS button. The invite SMS button then automatically composes an SMS message specifying the task and inviting the user to attend. This function is useful if a user has failed to respond to an e-mail invitation and was not initially invited by SMS message. The relationship column allows the user to specify the relationship of a user to the task. For example, John Smith is shown as the owner of the task, Fred Barnes is shown as a work colleague and Tony Soprano is shown as an associate.

The e-mail column 98 shows the user's e-mail address and the add contact column 99 allows a user either to add an additional contact by clicking on “Add a contact” to a task or to remove a contact.

Referring now to FIG. 9, there is shown the contact details for particular users. The user is Tony Soprano, and accordingly, the user's first name “Tony” is shown in the first name box 120 and the user's second name is shown in the second name box 121. The user's e-mail address shown in e-mail box 122, if the user had a group it would be shown in group box 123, the user's mobile (cellular) telephone number is shown in phone number box 124, the user's relationship to the user contacting the page can be specified in box 125 by selecting from a menu of available choices. Whether e-mail or SMS events should be sent to the user can be specified using send e-mails/SMS events buttons 126.

Accordingly, at the top of the page are the details the user has specified for Tony Soprano. One unique aspect of this system is the ease with which a new contact can be added to the system. The user merely needs to add a name and e-mail address to create an entity record for the user. The user to whom the record relates can subsequently specify additional detail such as that shown in the bottom half 127 of the contact detail page. Selecting the update button updates the contact information from the contact data base. The details which are published beyond the basic details of the name and e-mail address are those which are specified by the user to whom the contact details belong. Accordingly, the user can control the contact details which are available and also ensure that other users of the system easily obtain their updated contact details. For example, if the user changes e-mail address or phone numbers, the user merely needs to enter this into the contact data base. This will then be updated the next time other users attempt to access their contact details. The user also has control over what details are available. For example, in the contact details area 127 no occupation is specified for Tony Soprano and his date of birth is also blank. It will appreciated by persons skilled in the art that additional information can be displayed in this page—for example a photo.

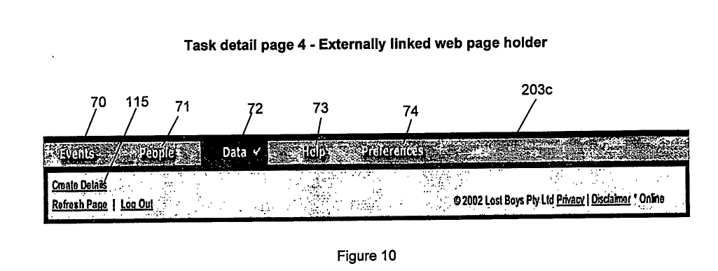

Referring now to FIG. 10, there is shown the data page of the secondary task detail page. This page would normally display all externally linked web pages. In this case there are no web pages linked to the task. The create detail button allows a user to add an additional web page.

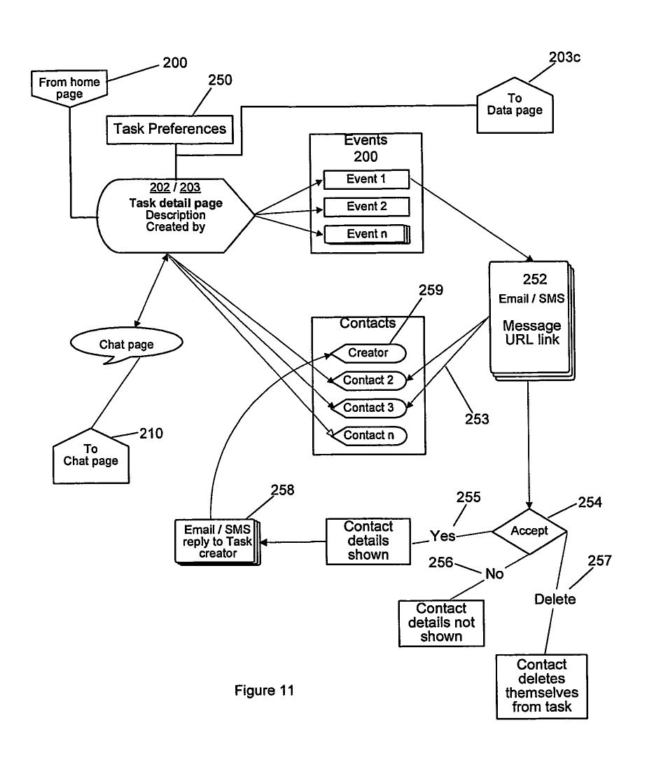

FIG. 11 shows the schematic relationships between the task detail pages 202 and 203, events, contacts and the other pages. The task detail pages are shown accessible from the home page and associated with a set of task preferences 250. A user can also access the chat page 210 and data page 203c.

As described above the task event association data base specifies the set of events 251 which are associated with this task from a particular event a user can send an e-mail message using e-mail/SMS program 252 to contacts (users) as indicated by arrows 253. Again, the users for this task are specified by the entity/task association data base. When a message regarding a new task 253 is sent to users, as indicated by box 254 they are presented with options to accept 255, reject 256 or delete 257 a task. If the user deletes themselves from the task, they are removed from the task totally, if the user declines the task 256 their contact details are not shown. If the user accepts the task 255 their contact details are shown in relation to the task and an e-mail or SMS message 258 is sent to the initiating user 259.

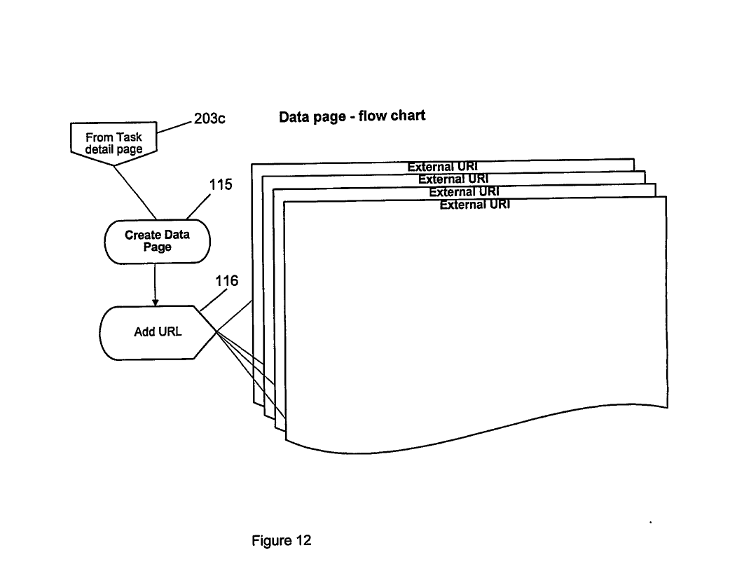

Referring to FIG. 12, from secondary task detail page 203c, the user can create data pages 115 and add one or more uris to external web pages. These external uris are live pages elsewhere on the Internet. A uri can either be loaded manually onto the page or, if the page has the relevant link embedded, the data page can be created automatically as will be described in more detail below.

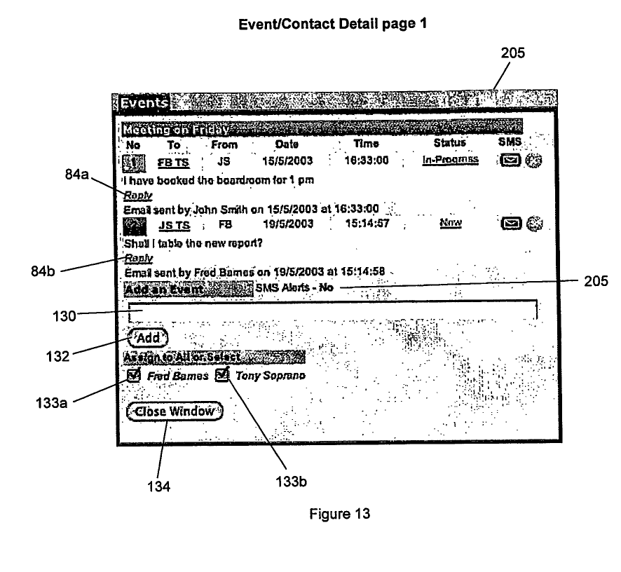

Referring now to FIG. 13, there is shown the event/contact detail page 205. This page is essentially a related view to page 203a but allows a user to add additional events.

Accordingly, this page will only be to describe to the extent that it is different to page 203a. Aside from some minor differences such as the relocation of the reply buttons 84a, 84b to different locations on the page, the detail is largely the same as that shown in FIG. 6. Add event box 130 allows a user to add details for example, the user may specify “Please proceed to table the new report”. The SMS alert status 131 is displayed immediately above the event box 130. This specifies whether an SMS alert will be sent to the user or users. Once the details of the event have been placed into event box 130 it can be added by pressing event box 32 and will be assigned to all users for whom checkboxes 133a, 133b have been checked. The user can close this window by pressing box 134.

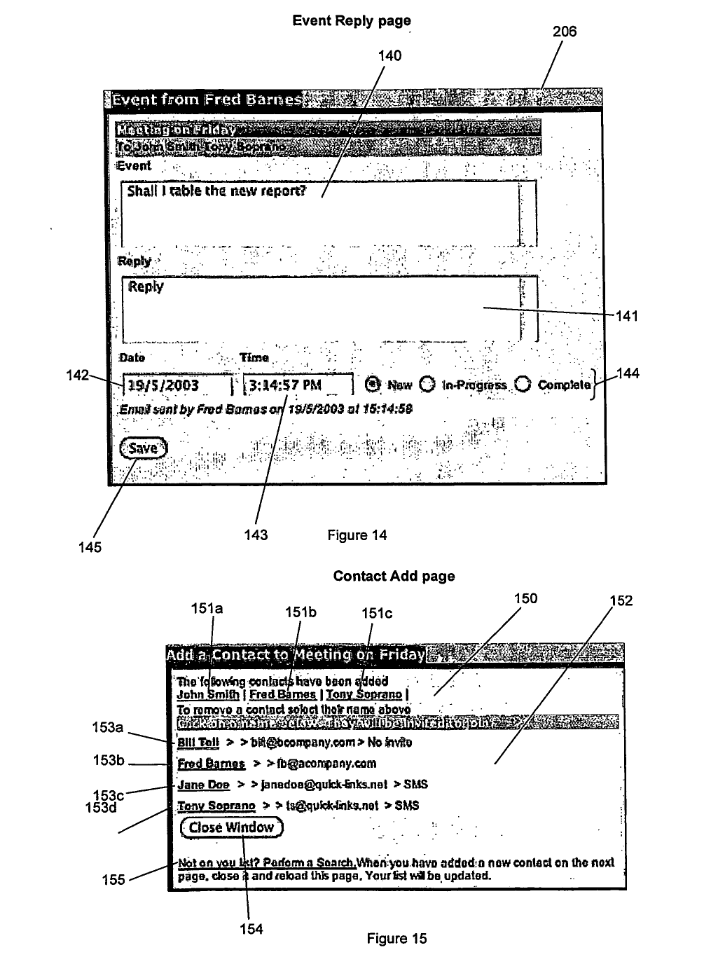

Shown in FIG. 14 is the event reply page 206 which is accessed when the user presses the reply button 84. In this case, the user has pressed reply button 84b which shows the detail of the event in box 140 and the user can reply in box 141. The date and time are shown in boxes 142 and 143 respectively and the event status can be edited using event status buttons 144. Once the user has entered their reply they can save the reply using save button 145 which adds the reply to the event details.

FIG. 15 shows the “add contact page” which can be accessed from the new task page 201 using button 43 or the task detail page 202 using add contact button 60.

The existing contacts box 150 shows the contacts that have already been added to a task. By clicking on names 151a, 151b and 151c users can be removed from the task provided they were added to the task by the user. Positioned below this area is a user list area 151 which specifies all users who are known to for the user adding the contact. This list of contacts can be produced from the entity/task association data base. Clicking on a name 153 will add this contact to the task if they have not been added to the task previously and send that user an e-mail message and an SMS message if SMS has been selected. For example, clicking on the name 153c will send an e-mail message and an SMS message to Jane Doe. Pressing close window 154 will return the user to the page from which they came.

If a contact is not on a user's list and the user wishes to add them, the user can select “search” which brings up search page 209 which will be discussed in further detail below.

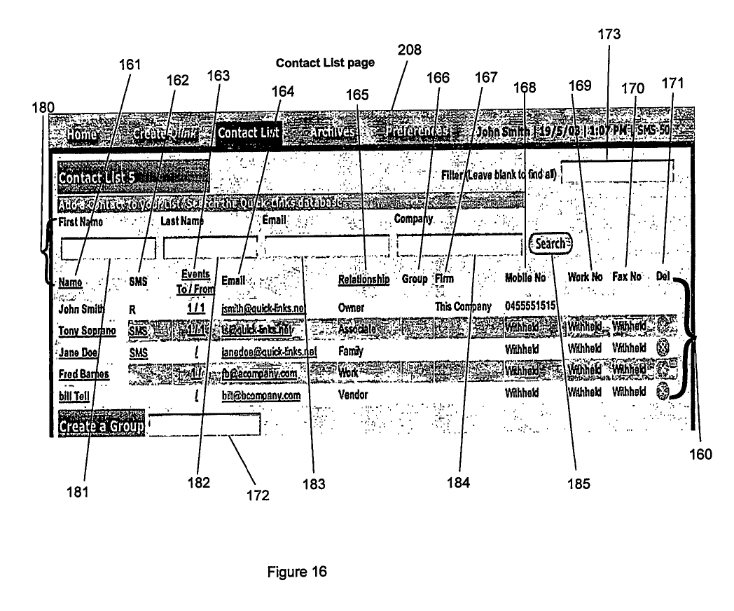

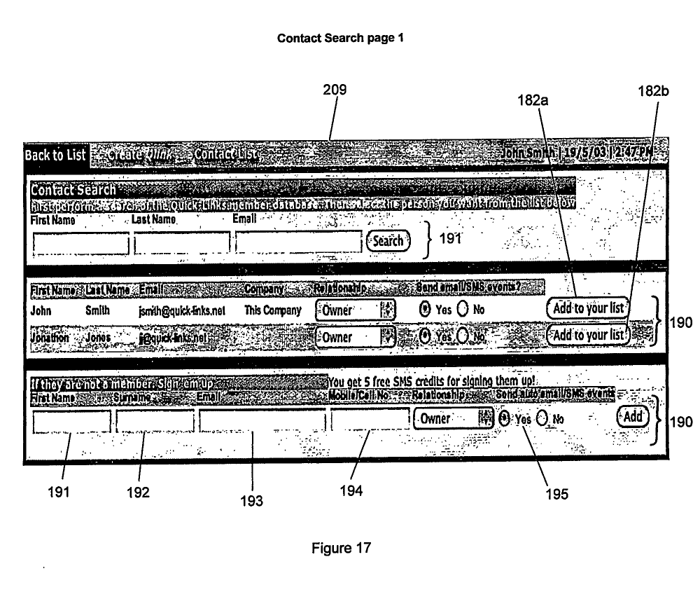

The user's contact page 208 is shown in FIG. 16. The contact page is accessible from the home page by pressing contact list tab 23.

The list of John Smith's contacts including John Smith is set out in contact area 160. Contact list area 160 has a number of columns: name 161 which specifies the names of the contacts, SMS status which specifies the user's SMS status which when clicked will enable free form SMS to be sent to that users device, the events column which specifies the number of events to or from that user, the user's e-mail address is specified in column 164, their relationship with the contact list is specified in list 165, whether they belong to any particular groups is specified in column 166 and additional details such as their firm 167, mobile number 168, work number 169, fax number 170 are specified in additional columns. There is also a delete contact column 171 that allows contacts to be deleted.

The “create a group” box 172 allows a user to specify particular users as belonging to a particular group.

A number of additional features are provided on the page, for example, there is a filter box 173 that allows the user to select which contacts are displayed. For example, entering the name Tony will only display contacts who have the name Tony.

If a user wants to add a contact to their list, they do this using add contact area 180. The user enters the first name 181, last name 182, e-mail address 183 and company name 184 into the relevant fields and then presses the search button.

The search engine then searches the entity data base for possible matches and produces a list of possible candidates. This is shown in the contact search page 209 where the entity search area 180 is duplicated and there is a list of possible matches in area 186. A user can add a user from this list to their list of contacts by pressing buttons 182a or 182b. If no contact is filed, the user uses the add area 190 to specify the new user, the user is then required to enter first name 191, surname 192, e-mail address 193, optionally, mobile number 194, relationship 195 and whether e-mail messages should be sent 196.

Persons skilled in art will appreciate that this detail can be automatically filled in from the search area 180.

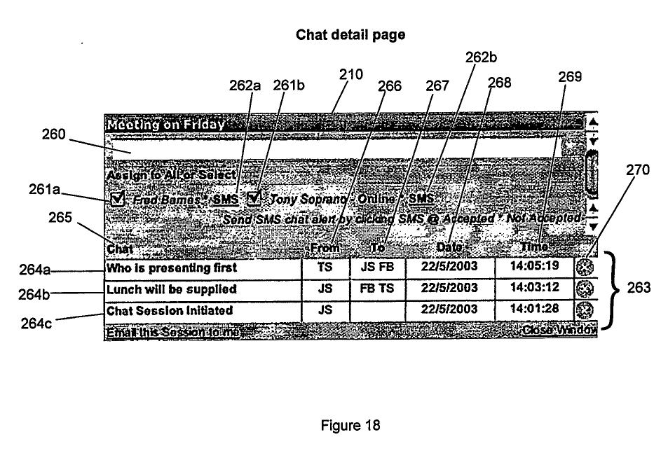

Referring to FIG. 18 there is shown a chat page 210 which can be accessed from the task page or home page as described above. The message area 260 allows the user to insert a message. Below the chat area are the list of users associated with the task. Checkboxes 261a, 261b allow the user to specify which contacts are invited to participate in the chat. SMS buttons 262a and 262b allow the user to send an SMS message notifying the users that a chat is in progress or about to begin. Chat history area 263 shows the series of messages 264c. The Chat column 265 includes the message. The “from” column 286 indicates who sent the message 266. Date and time columns 268, 269 indicate when the message was sent and the delete column 270 allows particular portions of the message to be deleted.

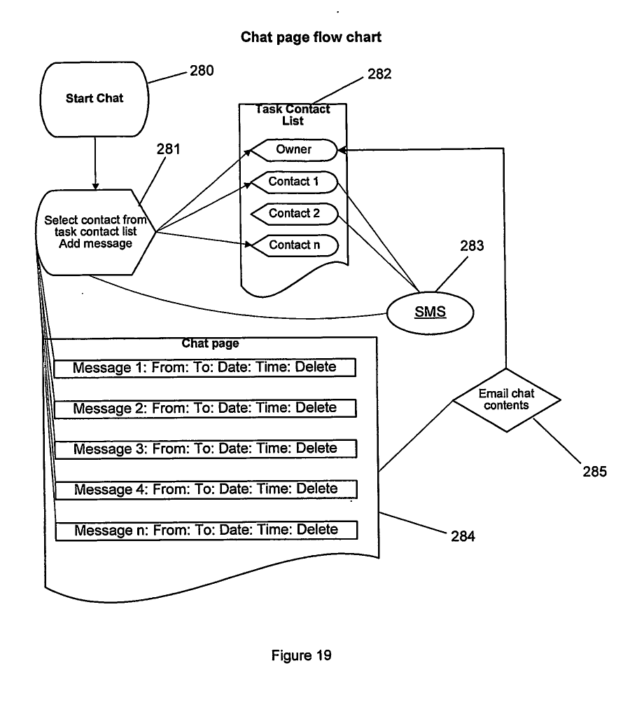

The chat flow chart is shown in FIG. 19 when a chat is started at step 280, the user selects contacts from their contact list and optionally sends as indicated by box 283 an SMS message to the contacts. A message is added to the chat page 284 which lists each of the messages and the chat contents are returned 285 to the owner and stored in relation to the task.

Referring now to FIG. 20, there is shown the preferences page 211 which is accessible using tab 25. Contact area 290 allows the user to manage their details including things such as password, e-mail addresses, phone numbers etc. As these have been described in some detail elsewhere they are not described further here. In the properties section 291, the user can specify the area 292 whether they can receive SMS alerts. The user can use the task selection button to specify for what types of task they will or won't receive SMS alerts. For example, the user may wish to receive SMS alerts for personal tasks that occur outside of work hours when they may not have access to their computer but not during work hours when they will be able to access their e-mails.

The user can specify, using selection buttons 294 and 295 respectively, whether they will receive SMSs when they are invited to join a task or when a new event is created. Refresh rate box 296 allows the user to specify how often their home page should be refreshed and update button 297 sends the user's updated contact details and properties to the contact data base.

SMS account detail 298 indicates the user's SMS account details. A user is required to maintain an SMS account if they wish to be able to use the system to send SMS messages. The SMS account details detail the number of SMS messages sent, the dollar figure spent, the number of credits they have (i.e. messages they can send) and the balance of their account. The user also has the option to buy additional SMS credits using buttons 299 that link the user to an external payment site where they can pay for additional SMS credits.

From the perspective of a new user of system, the user will typically be notified that they have been signed up to the system by receiving an e-mail message from a person they know.

The e-mail message will specify that the user is invited to join a task and include a title and subject of the task. The e-mail message will also include a task uri that will allow the new user to access a home page that will include the task in the manner described above for an existing user. Thus, the user is immediately connected to the system and able to participate in tasks without first having to register with the system. It will also be noted that the system is accessible from the user's browser and accordingly the user does not need to download any software.

Although the user does not need to submit their details in order to communicate in relation to the task, the initial home page prompts the new user to update their details—i.e. to include full address details, open an SMS account and to complete other such details as will be apparent from referring to the above description of an existing user.

There are also a number of additional ways in which a user can initiate the creation of a task.

In one embodiment, the user adds a uri to their browser which is named, conveniently as “create a quick-link”. This uri, in effect, contains a script which will add the subject page (i.e. the page the user is currently viewing) to a new task record and allocate a uri to that record when clicked on. The task record will then be viewable from the user's home page. Thus, the user is able to create a new task page using a single click of the mouse. The user may view the task and add contacts, in the manner described above. It will be noted that the user does not necessarily have to communicate this task to other users.

The browser record is typically a list of uris known as a “bookmark” in Netscape Navigator or as a set of “favorites” in Microsoft Internet Explorer, however, it will be appreciated that the appropriate script may be stored in any convenient manner it the user's browsers.

In the same vein, the user may have an additional uri named “add a page” stored in the same manner in the browser record that allows a user to add a subject page to an existing task. Thus, a user may be creating data page for a particular task, for example, the user may wish to create a list of possible cars which they wish to purchase. Once the task is created, a cookie is stored in the user's browser which lets the system know which is the “Active” quick-link, the “add a page” script is configured to add data including the uri of the subject page to the data page of the active task.

In addition to storing such links in the user's browser record, the link may be embedded in an existing web page. This can be used as a prompt to the user to create a new task record. Where the user is a new user, the user will be required to specify certain minimum details such as their e-mail address as described above so that the user can be added to the entity data base and an appropriate record can be added to the entity/task association data base.

In one embodiment, the link may be configured to automatically create a task with a predetermined user. It will be appreciated that in this case, the owner of the task can be set either as the predetermined user or the person who initiates creation of the task record. For example, a link entitled “create a quick-link with one of our sales people” may be located on a page for a new car. Clicking on the link may create a new task in which the salesperson is automatically added as the owner of the task and the user is prompted to enter their name and e-mail address in order to set up the task. The user is then transferred to the task page and can communicate with the salesperson, for example, by initiating a chat as described above. Thus, the initiating user and the owner of the task can be two different users, although in most cases the initiating user will be the owner.

In one embodiment, the uri that is emailed upon creation of a task and/or message “event” has a timed lifetime. That is, when an event is created, a recipient of the event has say, 24 hours to click the link, to be taken directly to the task page without being challenged by a login prompt. The reason for this feature is that some users may choose to store the messages sent to them and at a later date, click the link. Unauthorised users may take advantage of this to compromise another user's account. However, appropriate use of Quick-Links is to speed the communication process and to challenge users, especially new users, every time for password details would burden usage of the system. The setting of this timeout event is task or event specific and can be set to zero minutes for task labeled “Confidential” or infinity for tasks labeled e.g. “Public”.

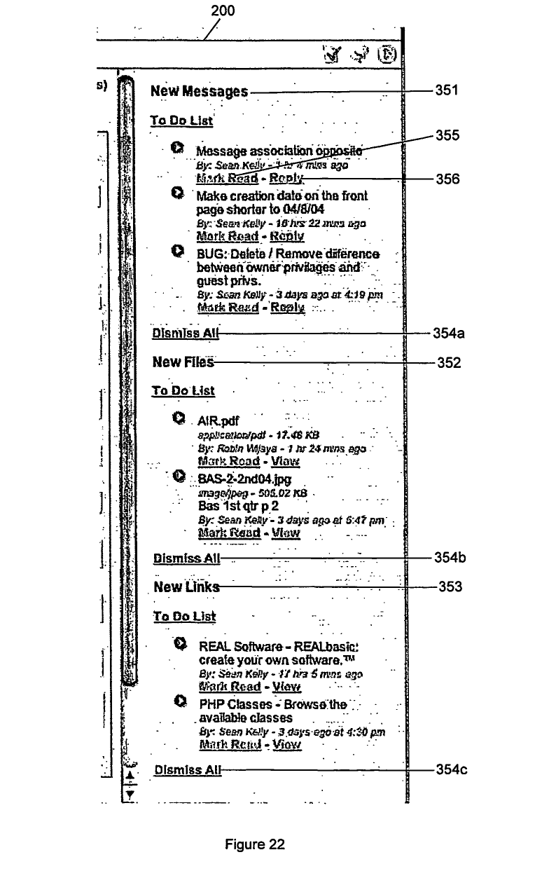

FIG. 22 illustrates an additional frame which in one embodiment is displayed as part of the user's homepage—in this example to the right of the user's homepage. This additional frame allows the user to monitor the system so that they can see when new tasks, events, links as they are added. This portion of the homepage is updated on a periodic basis (e.g. every minute). The frame is divided into three regions. A new message region 351 which relates to all new tasks or events created for the user, a new files portion 352 which includes all new files which relate to the user and a new links section 353 which relates to all new links that have been sent to the user.

The user has the option to dismiss these prompts using dismiss buttons 354 or to mark them as read using button 355 or to reply using button 356. Thus frame 350 provides an alternative view of the tasks and events associated with the user.

While the description of the preferred embodiment of the invention has relied on the terminology “clicking” to refer to a user selecting a button or link using a mouse and clicking on the button or link using the mouse button, persons skilled in the art will appreciate that the buttons or links could also be selected using keyboard commands, for example by tabbing or using arrow keys until an appropriate button is selected or by using so-called “hot keys”.

While one embodiment of the invention has been described herein, persons skilled in the art will appreciate that various modifications may be made to the system without departing from the scope of the invention. Such modifications should be understood as falling within the scope of the invention described herein.

1. A system for enabling a user to create at least one task, the system comprising:
a host server for hosting task pages once they have been created;
at least one user computer running a browser program operable by at least one user to access task pages hosted by said host server that said at least one user has permission to access; and
a task creator configured to create a task record in response to a command from an initiating user, the task record including a task universal resource indicator (uri) for each new task whereby said host server can create a task page from said task record that can be accessed using said task uri.

2. A system as claimed in claim 1, wherein said system comprises a plurality of user computers.

3. A system as claimed in claim 2, wherein said task creator is configured to allow the initiating user to specify at least one additional user for a task and to create an association record specifying the initiating user and any additional users specified by the initiating user, the association record defining the users who have permission to access the task page.

4. A system as claimed in claim 3, wherein the task creator is configured to dispatch a message including the task uri to the at least one additional user to thereby inform the at least one additional user of the task whereafter the at least one additional user can access said task page using a browser program run by the additional user's user computer.

5. A system as claimed in claim 4, comprising e-mail messaging means whereby the message dispatched is an e-mail message.

6. A system as claimed in claim 4, comprising SMS messaging means whereby the message dispatched is an SMS message.

7. A system as claimed in claim 1, wherein the task creator is a task creation program run by said host server which is operable using the browser program run by the initiating user's user computer.

8. A system as claimed in claim 1, wherein said task creator allows an initiating user to add at least one subject uri of at least one subject page to the task record, whereafter the task page includes the at least one subject uri whereby users can access the subject page from the task page.

9. A system as claimed in claim 1, wherein a task creation uri is placed on a subject page and the initiating user sends a command to said task creator by selecting the task creation uri whereafter the task creator creates a task record including the uri of the subject uri.

10. A system as claimed in claim 9, further comprising automatically adding an additional user to the task record.

11. A system as claimed in claim 1, further comprising a task creation uri stored in a uri record of an initiating user's browser, whereby when viewing a subject page an initiating user sends a command to said task creator by selecting the task creation uri from the uri record whereafter the task creator creates a task record including the subject uri.

12. A system as claimed in claim 1, wherein said host server hosts a home page for each user.

13. A system as claimed in claim 12, wherein said home page is configured such that users can access all tasks which they have permission to access from their respective home pages.

14. A system as claimed in claim 1, further comprising an event creator for creating events associated with a task.

15. A system as claimed in claim 14, wherein an event may be created from the task page.

16. A system as claimed in claim 1, further comprising chat means which allows users who have permission to access a task to chat to one another when they are logged onto the system at the same time.

17. A system as claimed in claim 16, wherein each task page has means for initiating a chat.

18. A system as claimed in claim 1, wherein said task creator is configured to allow specification of a lifetime for a task whereby during said lifetime a user who selects the task uri is directed immediately to the task page and outside said lifetime said user is required to confirm their identity.
